(19) United States
(12) Patent Application Publication
(10) Pub. No.: US 2008/0152845 A1
(43) Pub. Date: Jun. 26, 2008

(54) Thermosetting resin composition and cured film

(75) Inventor: Setsuo Itami, Ichihara-shi (JP)

Correspondence Address: HOGAN & HARTSON LLP;IP GROUP, COLUMBIA SQUARE, 555 THIRTEENTH STREET, N.W., WASHINGTON, DC, 20004, US

(73) Assignee: CHISSO Corporation

(21) Appl. No.: 12/000,999

(22) Filed: Dec. 19, 2007

(30) Foreign Application Priority Data
Dec. 26, 2006 (JP) 348994/2006

(51) Int. Cl. C08L 67/00; C09K 19/00

(52) U.S. Cl. 428/1.53; 525/418

(57) ABSTRACT

The invention provides a cured film, which is particularly excellent in flatness and heat resistance and is also excellent in solvent resistance, chemical resistance such as acid resistance, alkali resistance and the like, water resistance, ability to adhere to a substrate such as glass and the like, transparency, scratch resistance, coatability and light resistance, and a resin composition providing the cured film.

### CROSS REFERENCE TO RELATED APPLICATIONS

This application claims priority under 35 U.S.C. §119 to Japanese Patent Application No. JP 2006-348994, filed Dec. 26, 2006, which application is expressly incorporated herein by reference in its entirety.

### FIELD OF THE INVENTION

The invention relates to a thermosetting resin composition and a cured film which is obtained by heating and curing the thermosetting resin composition.

### BACKGROUND OF THE INVENTION

During the process for producing a device such as a liquid crystal display device, at the time of subjecting the device to a chemical treatment using various chemicals such as an organic solvent, an acid, an alkali solution and the like, or at the time of forming a film by sputtering to prepare an electrode of a wiring, the surface of the device may be locally highly-heated. In order to prevent deterioration, damage and change of properties of surfaces of various devices, surface protective films may be provided thereto. It is required that such protective films have properties for resisting the above-described various treatments during the production process. Specifically, it is required that such protective films have: heat resistance; chemical resistance such as solvent resistance, acid resistance, alkali resistance and the like; water resistance; ability to adhere to a substrate such as glass and the like; transparency; scratch resistance; coatability; flatness; light resistance for preventing change of properties such as coloring and the like for a long period of time; and the like. Moreover, particularly in recent years, technical advantages of liquid crystal display devices such as wider viewing angle, faster response, higher resolution and the like have been offered. Under such circumstances, when a material is used as a protective film for a color filter, it is desired that the material has improved flatness properties, and that the material has high heat resistance, wherein there is little degas (volatile component) during processes for being heated at a high temperature such as a sputtering process, a baking process and the like.

Examples of materials for protective films having these excellent properties include a silicon-containing polyamide acid composition (see, e.g., JP Laid Open No. H09(1997)-291150) and a polyester amide acid composition (see, e.g., JP Laid Open No. 2005-105264). The silicon-containing polyamide acid composition is a very excellent material in terms of flatness, but has the following drawbacks: an insufficient heat resistance and an inferior alkali resistance. The polyester amide acid composition has the following drawbacks: an insufficient flatness and an insufficient heat resistance. Therefore, any of these materials, as a material for a protective film, does not have sufficiently heat resistance, flatness and other properties.

Under the above-described circumstances, for example, a resin composition, which is excellent in chemical resistance such as solvent resistance, acid resistance, alkali resistance and the like, water resistance, ability to adhere to a substrate such as glass and the like, transparency, scratch resistance, coatability and light resistance, is desired. Further, a cured film, which is particularly excellent in flatness and heat resistance, and a resin composition providing the cured film, are desired.

### SUMMARY OF THE INVENTION

The invention provides a polyester amide acid obtained by reacting a compound including a tetracarboxylic dianhydride, a diamine and a multivalent hydroxy compound; an epoxy resin including 3 to 20 epoxy groups and having a weight-average molecular weight of less than 5,000; and an epoxy curing agent, and a cured film obtained by curing the resin composition.

The Invention Includes:

[1] A thermosetting resin composition comprising: a polyester amide acid obtained by reacting a tetracarboxylic dianhydride, a diamine and a multivalent hydroxy compound as essential components; an epoxy resin including 3 to 20 epoxy groups and having a weight-average molecular weight of less than 5,000; and an epoxy curing agent, wherein the epoxy resin is in an amount of 20 to 400 parts by weight per 100 parts by weight of the polyester amide acid, and wherein the epoxy curing agent is in an amount of 0 to 13 parts by weight per 100 parts by weight of the epoxy resin.

[2] The thermosetting resin composition according to item [1], wherein the polyester amide acid is a reaction product obtained by reacting a tetracarboxylic dianhydride, a diamine, a multivalent hydroxy compound and a monovalent alcohol as essential components.

[3] The thermosetting resin composition according to item [1], wherein the polyester amide acid is a reaction product obtained by reacting a tetracarboxylic dianhydride, a diamine, a multivalent hydroxy compound, a monovalent alcohol and a silicon-containing monoamine as essential components.

[4] The thermosetting resin composition according to item [3], wherein the silicon-containing monoamine comprises one or more substances selected from 3-aminopropyl triethoxysilane and p-aminophenyl trimethoxysilane.

[5] The thermosetting resin composition according to any of items [2] to [4], wherein the monovalent alcohol includes one or more substances selected from isopropyl alcohol, allyl alcohol, benzyl alcohol, hydroxyethyl methacrylate, propylene glycol monoethyl ether and 3-ethyl-3-hydroxymethyl oxetane.

[6] The thermosetting resin composition according to any of items [1] to [5], wherein the polyester amide acid is a polyester amide acid obtained by further reacting a styrene-maleic anhydride copolymer.

[7] The thermosetting resin composition according to any of items [1] to [6], wherein the polyester amide acid is obtained by reacting “X” moles of a tetracarboxylic dianhydride, “Y” moles of a diamine and “Z” moles of a multivalent hydroxy compound in a ratio which satisfies the relationships defined by formulae (1) and (2):

0.2≦Z/Y≦8.0 (1)

0.2≦(Y+Z)/X≦1.5 (2)

[8] The thermosetting resin composition according to any of items [1] to [7], wherein the polyester amide acid has constitutional units represented by the following general formulae (3) and (4):

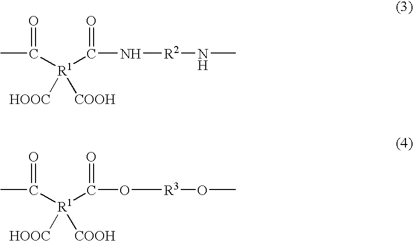

wherein R¹ is a tetracarboxylic dianhydride residue, R² is a diamine residue and R³ is a multivalent hydroxy compound residue.

[9] The thermosetting resin composition according to any of items [1] to [8], wherein the polyester amide acid has a weight-average molecular weight of 1,000 to 50,000.

[10] The thermosetting resin composition according to any of items [1] to [9], wherein the tetracarboxylic dianhydride includes one or more substances selected from 3,3′,4,4′-diphenylsulfone tetracarboxylic dianhydride, 3,3′,4,4′-diphenylether tetracarboxylic dianhydride, 2,2-[bis(3,4-dicarboxyphenyl)]hexafluoropropanedianhydride and ethylene glycol bis(anhydrotrimellitate).

[11] The thermosetting resin composition according to any of items [1] to [10], wherein the-diamine includes one or more substances selected from 3,3′-diaminodiphenyl sulfone and bis[4-(3-aminophenoxy)phenyl]sulfone.

[12] The thermosetting resin composition according to any of items [1] to [11], wherein the multivalent hydroxy compound includes one or more substances selected from ethylene glycol, propylene glycol, 1,4-butanediol, 1,5-pentanediol, 1,6-hexanediol, 1,7-heptanediol and 1,8-octanediol.

[13] The thermosetting resin composition according to any of items [1] to [12], wherein the epoxy resin is a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-1-methylethyl]phenyl]ethyl]phenoxy]-2-propanol, or 2-[4-(2,3-epoxy propoxy)phenyl]-2-[4-[1,1-bis[4-([2,3-epoxy propoxy]phenyl)]ethyl]phenyl]propane.

[14] The thermosetting resin composition according to any of items [1] to [13], wherein the epoxy curing agent includes one or more substances selected from trimellitic anhydride and hexahydrotrimellitic anhydride.

[15] The thermosetting resin composition according to any of items [1] to [4], wherein: the tetracarboxylic dianhydride is 3,3′,4,4′-diphenylether tetracarboxylic dianhydride; the diamine is 3,3′-diaminodiphenyl sulfone; the multivalent hydroxy compound is 1,4-butanediol; the epoxy resin is a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-1-methylethyl]phenyl]ethyl]phenoxy]-2-propanol, or 2-[4-(2,3-epoxy propoxy)phenyl]-2-[4-[1,1-bis[4-([2,3-epoxy propoxy]phenyl)]ethyl]phenyl]propane; and the epoxy curing agent is trimellitic anhydride, the thermosetting resin composition further including methyl 3-methoxypropionate as a solvent.

[16] The thermosetting resin composition according to any of items [2] to [4], wherein: the tetracarboxylic dianhydride is 3,3′,4,4′-diphenylether tetracarboxylic dianhydride; the diamine is 3,3′-diaminodiphenyl sulfone; the multivalent hydroxy compound is 1,4-butanediol; the monovalent alcohol is benzyl alcohol; the epoxy resin is a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-1-methylethyl]phenyl]ethyl]phenoxy]-2-propanol, or 2-[4-(2,3-epoxy propoxy)phenyl]-2-[4-[1,1 -bis[4-([2,3-epoxy propoxy]phenyl)]ethyl]phenyl]propane; and the epoxy curing agent is trimellitic anhydride, the thermosetting resin composition further including methyl 3-methoxypropionate as a solvent.

[17] A cured film obtained from the thermosetting resin composition according to any of items [1] to [16].

[18] A color filter using the cured film according to item [17] as a protective film.

[19] A liquid crystal display device using the color filter according to item [18].

[20] A solid-state image sensing device using the color filter according to item [18].

[21] A liquid crystal display device using the cured film according to item [17] as a transparent insulating film formed between a TFT and a transparent electrode.

[22] A liquid crystal display device using the cured film according to item [17] as a transparent insulating film formed between a transparent electrode and an aligning film.

[23] An LED illuminant using the cured film according to item [17] as a protective film.

A thermosetting resin composition according to a preferred embodiment of the invention is particularly excellent in flatness and heat resistance. When using the composition as a protective film for a color filter of a color liquid crystal display device, visual quality and reliability thereof can be improved. Moreover, a cured film obtained by heating the thermosetting resin composition according to the preferred embodiment of the invention has well-balanced transparency, chemical resistance, adhesiveness and sputter resistance, and therefore is highly practical. In particular, the cured film is useful as a protective film for a color filter produced by means of a staining method, a pigment dispersion method, an electrodeposition method or a printing method. The cured film can also be used as a protective film for various optical materials and a transparent insulating film.

### DETAILED DESCRIPTION OF THE INVENTION

1. Thermosetting Resin Composition

The thermosetting resin composition of the invention is a thermosetting resin composition including a polyester amide acid obtained by reacting a tetracarboxylic dianhydride, a diamine and a multivalent hydroxy compound as essential components; an epoxy resin including 3 to 20 epoxy groups and having a weight-average molecular weight of less than 5,000; and an epoxy curing agent, wherein the epoxy resin is in an amount of 20 to 400 parts by weight per 100 parts by weight of the polyester amide acid, and wherein the epoxy curing agent is in an amount of 0 to 13 parts by weight per 100 parts by weight of the epoxy resin.

At least a solvent is necessary for synthesis of the polyester amide acid. The solvent may be retained to provide a liquid-type or gel-type thermosetting resin composition in view of handling ability and the like. The solvent may be removed to provide a solid-type composition in view of transportability and the like. Moreover, a monovalent alcohol, a styrene-maleic anhydride copolymer and a silicon-containing monoamine may be optionally included as raw materials for synthesis of the polyester amide acid. Among them, a monovalent alcohol is preferably included.

1.1 Tetracarboxylic Dianhydride

Specific examples of the tetracarboxylic dianhydrides used in the invention include: aromatic tetracarboxylic dianhydrides such as 3,3′,4,4′-benzophenone tetracarboxylic dianhydride, 2,2′,3,3′-benzophenone tetracarboxylic dianhydride, 2,3,3′,4′-benzophenone tetracarboxylic dianhydride, 3,3′,4,4′-diphenylsulfone tetracarboxylic dianhydride, 2,2′,3,3′-diphenylsulfone tetracarboxylic dianhydride, 2,3,3′,4′-diphenylsulfone tetracarboxylic dianhydride, 3,3′,4,4′-diphenylether tetracarboxylic dianhydride, 2,2′,3,3′-diphenylether tetracarboxylic dianhydride, 2,3,3′,4′-diphenylether tetracarboxylic dianhydride, 2,2-[bis(3,4-dicarboxyphenyl)]hexafluoropropanedianhydride, ethylene glycol bis(anhydrotrimellitate) (trade name: TMEG-100, manufactured by New Japan Chemical Co., Ltd.) and the like; alicyclic tetracarboxylic dianhydrides such as cyclobutanetetracarboxylic dianhydride, methylcyclobutanetetracarboxylic dianhydride, cyclopentanetetracarboxylic dianhydride, cyclohexanetetracarboxylic dianhydride and the like; aliphatic tetracarboxylic dianhydrides such as ethanetetracarboxylic dianhydride, butanetetracarboxylic dianhydride and the like; and the like.

Among the above-described examples, 3,3′,4,4′-diphenylsulfone tetracarboxylic dianhydride, 3,3′,4,4′-diphenylether tetracarboxylic dianhydride, 2,2-[bis(3,4-dicarboxyphenyl)]hexafluoropropanedianhydride, and ethylene glycol bis(anhydrotrimellitate) (trade name: TMEG-100, manufactured by New Japan Chemical Co., Ltd.) are preferred since they provide a resin having good transparency. 3,3′,4,4′-diphenylether tetracarboxylic dianhydride and 3,3′,4,4′-diphenylsulfone tetracarboxylic dianhydride are particularly preferred.

1.2 Diamine

Specific examples of the diamines used in the invention include: 4,4′-diaminodiphenyl sulfone, 3,3′-diaminodiphenyl sulfone, 3,4′-diaminodiphenyl sulfone, bis[4-(4-aminophenoxy)phenyl]sulfone, bis[4-(3-aminophenoxy)phenyl]sulfone, bis[3-(4-aminophenoxy)phenyl]sulfone, [4-(4-amino phenoxy)phenyl][3-(4-aminophenoxy)phenyl]sulfone, [4-(3-aminophenoxy)phenyl][3-(4-amino phenoxy)phenyl]sulfone, 2,2-bis[4-(4-aminophenoxy)phenyl]hexafluoropropane and the like.

Among the above-described examples, 3,3′-diaminodiphenyl sulfone and bis[4-(3-aminophenoxy)phenyl]sulfone are preferred since they provide a resin having good transparency. 3,3′-diaminodiphenyl sulfone is particularly preferred.

1.3 Multivalent Hydroxy Compound

Specific examples of the multivalent hydroxy compounds used in the invention include ethylene glycol, diethylene glycol, triethylene glycol, tetraethylene glycol, polyethylene glycol having a molecular weight of 1,000 or less, propylene glycol, dipropylene glycol, tripropylene glycol, tetrapropylene glycol, polypropylene glycol having a molecular weight of 1,000 or less, 1,2-butanediol, 1,3-butanediol, 1,4-butanediol, 1,2-pentanediol, 1,5-pentanediol, 2,4-pentanediol, 1,2,5-pentanetriol, 1,2-hexanediol, 1,6-hexanediol, 2,5-hexanediol, 1,2,6-hexanetriol, 1,2-heptanediol, 1,7-heptanediol, 1,2,7-heptanetriol, 1,2-octanediol, 1,8-octanediol, 3,6-octanediol, 1,2,8-octanetriol, 1,2-nonanediol, 1,9-nonanediol, 1,2,9-nonanetriol, 1,2-decanediol, 1,10-decanediol, 1,2,10-decanetriol, 1,2-dodecanediol, 1,12-dodecanediol, glycerin, trimethylolpropane, pentaerythritol, dipentaerythritol, bisphenol A (trade name), bisphenol S (trade name), bisphenol F (trade name), diethanolamine, triethanolamine and the like.

Among the above-described examples, ethylene glycol, propylene glycol, 1,4-butanediol, 1,5-pentanediol, 1,6-hexanediol, 1,7-heptanediol and 1,8-octanediol, which have good solubility in solvents, are preferred. 1,4-butanediol, 1,5-pentanediol and 1,6-hexanediol are particularly preferred.

1.4 Monovalent Alcohol

Specific examples of the monovalent alcohols used in the invention include methanol, ethanol, 1-propanol, isopropyl alcohol, allyl alcohol, benzyl alcohol, hydroxyethyl methacrylate, propylene glycol monoethyl ether, propylene glycol monomethyl ether, dipropylene glycol monoethyl ether, dipropylene glycol monomethyl ether, ethylene glycol monoethyl ether, ethylene glycol monomethyl ether, diethylene glycol monoethyl ether, diethylene glycol monoethyl ether, phenol, borneol, maltol, linalool, terpineol, dimethyl benzyl carbinol, 3-ethyl-3-hydroxymethyl oxetane and the like.

Among the above-described examples, isopropyl alcohol, allyl alcohol, benzyl alcohol, hydroxyethyl methacrylate, propylene glycol monoethyl ether and 3-ethyl-3-hydroxymethyl oxetane are preferred. In consideration of compatibility at the time of mixing a polyester amide acid produced using these substances, an epoxy resin and an epoxy curing agent and coatability of a thermosetting resin composition as a final product on a color filter, benzyl alcohol is more preferably used as a monovalent alcohol.

1.5 Silicon-Containing Monoamine

Specific examples of the silicon-containing monoamines used in the invention include 3-aminopropyl trimethoxysilane, 3-aminopropyl triethoxysilane, 3-aminopropyl methyldimethoxy silane, 3-aminopropyl methyldiethoxy silane, 4-aminobutyl trimethoxysilane, 4-aminobutyl triethoxysilane, 4-aminobutyl methyldiethoxysilane, p-aminophenyl trimethoxysilane, p-aminophenyl triethoxysilane, p-aminophenyl methyldimethoxysilane, p-aminophenyl methyldiethoxysilane, m-aminophenyl trimethoxysilane, m-aminophenyl methyldiethoxysilane and the like.

Among the above-described examples, 3-aminopropyl triethoxysilane and p-aminophenyl trimethoxysilane, which provide good acid resistance of coating films, are preferred. 3-aminopropyl triethoxysilane is particularly preferred.

1.6 Solvent to be Used in Polymerization Reaction

Specific examples of the solvents used in a polymerization reaction for obtaining a polyester amide acid include diethylene glycol dimethyl ether, diethylene glycol methyl ethyl ether, diethylene glycol diethyl ether, diethylene glycol monoethyl ether acetate, ethylene glycol monoethyl ether acetate, propylene glycol monomethyl ether acetate, methyl 3-methoxypropionate, ethyl 3-ethoxypropionate, ethyl lactate, cyclohexanone, N-methyl-2-pyrrolidone, N,N-dimethylacetamide and the like.

Among the above-described examples, propylene glycol monomethyl ether acetate, methyl 3-methoxypropionate and diethylene glycol methyl ethyl ether are preferred.

These solvents can be used solely. Further, two or more of these solvents can be used in combination as a combined solvent. Moreover, a solvent other than the above-described solvents can be mixed therewith at a ratio of approximately 30 wt % or less.

1.7 Method for Producing a Polyester Amide Acid

In the method for producing the polyester amide acid used in the invention, “X” moles of a tetracarboxylic dianhydride, “Y” moles of a diamine and “Z” moles of a multivalent hydroxy compound are reacted in the above-described solvent. The ratio between X, Y and Z is preferably determined to satisfy relationships defined in formulae (1) and (2) described below. Within the ranges described below, the polyester amide acid has a high solubility in solvents, and therefore, coatability of the composition is improved. As a result, a cured film having an excellent flatness can be obtained.

0.2≦Z/Y≦8.0 (1)

0.2≦(Y+Z)/X≦1.5 (2)

### The relationship defined in formula (1) is preferably 0.7≦Z/Y≦7.0, and more preferably 1.3≦Z/Y≦7.0. The relationship defined in formula (2) is preferably 0.5≦(Y+Z)/X≦0.9, and more preferably 0.7≦(Y+Z)/X≦0.8.

When the polyester amide acid used in the invention has an acid anhydride group at its molecular end, the above-described monovalent alcohol can be optionally added to be reacted. The polyester amide acid obtained by reacting with the monovalent alcohol added has an improved compatibility with the epoxy resin and the epoxy curing agent, and at the same time, coatability of the thermosetting resin composition of the invention including them is improved.

When the above-described silicon-containing monoamine is reacted with the polyester amide acid having an acid anhydride group at its molecular end, acid resistance of the coating film obtained is improved. Moreover, the monovalent alcohol and the silicon-containing monoamine can be reacted with the polyester amide acid simultaneously.

100 parts by weight or more of the reaction solvent is preferably used per 100 parts by weight of the tetracarboxylic dianhydride, the diamine and the multivalent hydroxy compound in total for the purpose of smooth progress of the reaction. The reaction is preferably performed at 40 to 200° C. for 0.2 to 20 hours. When the silicon-containing monoamine is reacted, it is preferred that, after the reaction of the tetracarboxylic dianhydride, the diamine and the multivalent hydroxy compound is completed, the reaction solution is cooled to 40° C. or less, and thereafter the silicon-containing monoamine is added to the reaction solution to be reacted at 10 to 40° C. for 0.1 to 6 hours. The monovalent alcohol may be added at any time during the reaction.

The addition order of the reaction raw materials to be added to a reaction system is not particularly limited. That is, any of the following methods can be used: the tetracarboxylic dianhydride, the diamine and the multivalent hydroxy compound are simultaneously added to the reaction solvent; the diamine and the multivalent hydroxy compound are dissolved in the reaction solvent, and thereafter the tetracarboxylic dianhydride is added thereto; the tetracarboxylic dianhydride is reacted with the multivalent hydroxy compound in advance, and thereafter the diamine is added to the reaction product; the tetracarboxylic dianhydride is reacted with the diamine in advance, and thereafter the multivalent hydroxy compound is added to the reaction product; and the like.

Moreover, the polyester amide acid used in the invention can be produced by a synthesis reaction performed by adding a compound having 3 or more acid anhydride groups. Specific examples of the compounds having 3 or more acid anhydride groups include a styrene-maleic anhydride copolymer. With respect to the ratio of components constituting the styrene-maleic anhydride copolymer, the molar ratio of styrene/maleic anhydride is approximately 0.5 to approximately 4, preferably approximately 1 to approximately 3. Specifically, approximately 1, approximately 2 or approximately 3 is more preferred, approximately 1 or approximately 2 is even more preferred, and approximately 1 is particularly preferred.

Specific examples of the styrene-maleic anhydride copolymers include commercially-available products such as SMA3000P, SMA2000P and SMA1000P manufactured by Kawahara Yuka Co., Ltd. Among them, SMA1000P, which has good heat resistance and alkali resistance, is particularly preferred.

The polyester amide acid thus synthesized comprises constitutional units represented by the aforementioned general formulae (3) and (4). The terminus thereof is preferably an acid anhydride group, an amino group or a hydroxyl group derived from the tetracarboxylic dianhydride, the diamine or the multivalent hydroxy compound, or is preferably constituted by an added substance other than these compounds. In the general formulae (3) and (4), R¹ is a tetracarboxylic dianhydride residue, and is preferably an organic group having 2 to 30 carbon atoms. R² is a diamine residue, and is preferably an organic group having 2 to 30 carbon atoms. R³ is a multivalent hydroxy compound residue, and is preferably an organic group having 2 to 20 carbon atoms.

The weight-average molecular weight of the obtained polyester amide acid is preferably approximately 1,000 to approximately 50,000, and more preferably approximately 3,000 to approximately 20,000. Within the ranges, the polyester amide acid has good flatness and heat resistance.

1.8 Epoxy Resin

The epoxy resin comprising 3 to 20 epoxy groups and having a weight-average molecular weight of less than approximately 5,000 used in the invention is not particularly limited as long as it has good compatibility with other components which form the thermosetting resin composition of the invention. The number of epoxy groups contained in the epoxy resin is preferably 3 to 15, more preferably 3 to 6, and even more preferably 3. Within the ranges, good heat resistance is attained. The weight-average molecular weight of the epoxy resin is preferably approximately 200 to approximately 3,000, more preferably approximately 200 to approximately 2,000, and even more preferably approximately 200 to approximately 1,000. Within the ranges, good flatness is attained.

Preferred examples of epoxy resins include phenol novolac type epoxy resin, cresol novolac type epoxy resin, glycidyl ether type epoxy resin, bisphenol A novolac type epoxy resin, aliphatic polyglycidyl ether, cyclic aliphatic epoxy resin and the like. Among them, glycidyl ether type epoxy resin, bisphenol A novolac type epoxy resin, phenol novolac type epoxy resin and cresol novolac type epoxy resin are particularly preferable since they have excellent heat resistance.

As specific examples of epoxy resins, a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-2-methyl ethyl]phenyl]ethyl]phenoxy]-2-propanol, and 2-[4-(2,3-epoxy propoxy)phenyl]-2-[4-[1,1-bis[4-([2,3-epoxy propoxy]phenyl)]ethyl]phenyl]propane are particular Moreover, commercially-available products as described below can be used as these epoxy resins.

Examples of glycidyl ether type epoxy resins comprising 3 to 20 epoxy groups and having a weight-average molecular weight of less than approximately 5,000 include: TECHMORE VG3101L (trade name, manufactured by Mitsui Chemicals, Inc.); EPPN-501H, 502H (trade names, manufactured by Nippon Kayaku Co., Ltd.); JER 1032H60 (trade name, manufactured by Japan Epoxy Resins Co., Ltd.); and the like. Examples of bisphenol A novolac type epoxy resins include JER 157S65, 157S70 (trade names, manufactured by Japan Epoxy Resins Co., Ltd.) and the like. Examples of phenol novolac type epoxy resins include EPPN-201 (trade name, manufactured by Nippon Kayaku Co., Ltd.), JER 152, 154 (trade names, manufactured by Japan Epoxy Resins Co., Ltd.) and the like. Examples of cresol novolac type epoxy resins include EOCN-102S, 103S, 104S, 1020 (trade names, manufactured by Nippon Kayaku Co., Ltd.) and the like.

1.9 Epoxy Curing Agent

In order to improve flatness and chemical resistance, an epoxy curing agent may be added to the thermosetting resin composition of the invention. Examples of epoxy curing agents include acid anhydride-based curing agents, polyamine-based curing agents, polyphenol-based curing agents, catalyst-type curing agents and the like. Acid anhydride-based curing agents are preferable in terms of coloring and heat resistance.

Specific examples of acid anhydride-based curing agents include: aliphatic dicarboxylic anhydrides such as maleic anhydride, tetrahydrophthalic anhydride, hexahydrophthalic anhydride, methylhexahydrophthalic anhydride, hexahydrotrimellitic anhydride and the like; aromatic polyvalent carboxylic anhydrides such as phthalic anhydride, trimellitic anhydride and the like; styrene-maleic anhydride copolymer; and the like. Among them, trimellitic anhydride and hexahydrotrimellitic anhydride are particularly preferable in terms of balance between heat resistance and solubility in solvents.

1.10 Ratio Between Polyester Amide Acid, Epoxy Resin and Epoxy Curing Agent

In the thermosetting resin composition of the invention, approximately 20 to approximately 400 parts by weight of the epoxy resin is used per approximately 100 parts by weight of the polyester amide acid. When the amount of the epoxy resin is within this range, flatness, heat resistance, chemical resistance and adhesiveness are well balanced. The amount of the epoxy resin is more preferably in the range from approximately 50 to approximately 250 parts by weight.

In the case where an epoxy curing agent is added in order to improve flatness and chemical resistance, regarding the ratio between the epoxy resin and the epoxy curing agent, 0 to approximately 13 parts by weight of the epoxy curing agent is used per approximately 100 parts by weight of epoxy groups. Approximately 5 to approximately 13 parts by weight is preferable. Approximately 8 to approximately 11 parts by weight is more preferable. With respect to the adding amount of the epoxy curing agent in detail, the epoxy curing agent is preferably added so that the amount of carboxylic anhydride groups or carboxylic acid groups in the epoxy curing agent is approximately 0.1 to approximately 1.5 times by equivalent per an epoxy group. At the time of calculation, carboxylic anhydride groups are divalent. When the addition is carried out so that the amount of carboxylic anhydride groups or carboxylic acid groups is approximately 0.15 to approximately 0.8 times by equivalent, it is more preferable since flatness and chemical resistance are further improved.

1.11 Other Constituent Materials of Thermosetting Resin Composition

As the solvent to be used in the resin composition of the invention, a solvent used in a polymerization reaction at the time of synthesizing a polyester amide acid can be used. The solid content of the above-described thermosetting resin composition is selected depending on the thickness of the coating film. In general, approximately 5 to approximately 40 parts by weight of the solid content is contained in approximately 100 parts by weight of the resin composition. The amount of the solvent can be suitably determined in relation to handling of the resin composition and the like. According to circumstances, for example, the solvent may be removed from the resin composition to provide the resin composition in the solid state.

According to need, the thermosetting resin composition of the invention may contain components other than those described above without departing from the purpose of the invention. Examples of such other components include a coupling agent, a surfactant, an antioxidant and the like.

The coupling agent is used in order to improve adhesiveness to a substrate. Per approximately 100 parts by weight of the solid content in the above-described thermosetting resin composition (the remaining components in the resin composition after the solvent is removed therefrom), approximately 10 parts by weight or less of the coupling agent is used to be added thereto.

As the coupling agent, silane-based, aluminum-based, and titanate-based compounds can be used.

Specific examples of the coupling agents include: silane-based compounds such as 3-glycidoxypropyl dimethylethoxysilane, 3-glycidoxypropyl methyldiethoxysilane, 3-glycidoxypropyl trimethoxysilane and the like; aluminum-based compounds such as acetalkoxy aluminum diisopropylate and the like; and titanate-based compounds such as tetraisopropyl bis(dioctylphosphite)titanate and the like. Among them, 3-glycidoxypropyl trimethoxysilane is preferable since it improves adhesiveness more effectively.

The surfactant is used in order to improve wettability, leveling ability or coatability with respect to substrates. Per approximately 100 parts by weight of the above-described thermosetting resin composition, approximately 0.01 to approximately 1 parts by weigh of the surfactant is used to be added thereto. As the surfactant, silicon-based surfactants, acrylic surfactants, fluorine-based surfactants and the like are used. Specific examples of the surfactants include: silicon-based surfactants such as Byk-300, Byk-306, Byk-335, Byk-310, Byk-341, Byk-344, and Byk-370 (trade names, manufactured by BYK-Chemie GmbH) and the like; acrylic surfactants such as Byk-354, ByK-358, and Byk-361 (trade names, manufactured by BYK-Chemie GmbH) and the like; DFX-18, FTERGENT 250, and FTERGENT 251 (trade names, manufactured by Neos Company Limited) and the like.

The antioxidant is used in order to improve transparency and to prevent yellowing when a cured film is exposed to high temperature conditions. Per approximately 100 parts by weight of the solid content in the above-described thermosetting resin composition (the remaining components in the resin composition after the solvent is removed therefrom), approximately 0.1 to approximately 3 parts by weight of the antioxidant is used to be added thereto. As the antioxidant, hindered amine-based antioxidants, hindered phenol-based antioxidants and the like are used. Specific examples of the antioxidants include: IRGAFOS XP40, IRGAFOS XP60, IRGANOX 1010, IRGANOX 1035, IRGANOX 1076, IRGANOX 1135, IRGANOX 1520L (trade names, manufactured by Ciba Specialty Chemicals) and the like.

2. Cured Film Obtained from Thermosetting Resin Composition

The thermosetting resin composition of the invention can be obtained by mixing the polyester amide acid and the epoxy resin, and depending on targeted properties, further adding the solvent, the epoxy curing agent, the coupling agent and the surfactant thereto optionally, and homogeneously mixing and dissolving the materials.

When the thermosetting resin composition prepared as described above (in the case where the thermosetting resin composition is in the solid state without the solvent, the resin composition is dissolved in the solvent in advance) is applied on the surface of a substrate and the solvent is removed by means of heating or the like, a coating film can be formed. When applying the thermosetting resin composition on the surface of the substrate, conventional and publicly-known methods such as a spin coating method, a roll coating method, a dipping method, a slit coating method and the like can be employed to form a coating film. Next, the coating film is heated (prebaked) with a hot plate, an oven or the like. Heat conditions vary depending on the type and compounding ratio of each of the components. Usually, the coating film is heated at approximately 70 to approximately 120° C., for approximately 5 to approximately 15 minutes (in the case of an oven), or for 1 to 5 minutes (in the case of a hot plate). After that, for the purpose of curing, the coating film is subjected to a heat treatment at approximately 180 to approximately 250° C., preferably at approximately 200 to approximately 250° C., for approximately 30 to approximately 90 minutes (in the case of the oven), or for approximately 5 to approximately 30 minutes (in the case of a hot plate), thereby obtaining a cured film.

With respect to the cured film obtained as described above, at the time of heating: 1) the polyamide acid portion of the polyester amide acid is cyclodehydrated to form an imide bond; 2) carboxylic acid in the polyester amide acid reacts with the epoxy resin to be polymerized; and 3) the epoxy resin is cured to be polymerized. Therefore, the cured film is very tough and is excellent in transparency, heat resistance, chemical substance, flatness, adhesiveness and sputter resistance. Accordingly, the cured film of the invention is effective when using as a protective film for a color filter. Using this color filter, a liquid crystal display device and a solid-state image sensing device can be produced. Moreover, other than the protective film for the color filter, the cured film of the invention is also effective when using as a transparent insulating film formed between a TFT and a transparent electrode, or a transparent insulating film formed between a transparent electrode and an aligning film. Furthermore, the cured film of the invention is also effective when using as a protective film for an LED illuminant.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

Hereinafter, the invention will be described in detail by way of Synthesis Examples, Examples and Comparative Examples. The invention is not limited by these examples.

Firstly, a polyester amide acid solution including a reaction product of a tetracarboxylic dianhydride, a diamine and a multivalent hydroxy compound was synthesized as described below (see, Synthesis Examples 1 and 2 and Table 1).

### Synthesis Example 1

446.96 g of dehydrated and purified methyl 3-methoxypropionate (hereinafter abbreviated as “MMP”), 31.93 g of 1,4-butanediol, 25.54 g of benzyl alcohol and 183.20 g of 3,3′,4,4′-diphenylether tetracarboxylic dianhydride (hereinafter abbreviated as “ODPA”) were put into a 1000 mL four-neck flask equipped with a thermometer, a stirrer, a raw material feed port and a nitrogen gas inlet, and the mixture was stirred under a dry nitrogen gas stream at 130° C. for 3 hours. After that, the reaction solution was cooled to 25° C., 29.33 g of 3,3′-diaminodiphenyl sulfone (hereinafter abbreviated as “DDS”) and 183.04 g of MMP were added to the reaction solution and the mixture was stirred at 20 to 30° C. for 2 hours. After that, the mixture was stirred at 115° C. for 1 hour and cooled to 30° C. or lower, thereby obtaining 30 wt % polyester amide acid solution which was pale yellow and transparent.

The rotational viscosity of the solution was 28.5 mPa·s. The term “rotational viscosity” used herein refers to a viscosity measured at 25° C. using an E type viscometer (trade name: VISCONIC END, manufactured by Tokyo Keiki Co., Ltd.) (the same applies to the following). The weight-average molecular weight measured with GPC was 4,200 (in the polystyrene conversion).

### Synthesis Example 2

504.00 g of dehydrated and purified propylene glycol monomethyl ether acetate (hereinafter abbreviated as “PGMEA”), 47.68 g of ODPA, 144.97 g of SMA1000P (trade name; styrene-maleic anhydride copolymer, manufactured by Kawahara Yuka Co., Ltd.), 55.40 g of benzyl alcohol, 9.23 g of 1,4-butanediol, and 96.32 g of dehydrated and purified diethylene glycol methyl ethyl ether (hereinafter abbreviated as “EDM”) were put, in this order, into a 1000 mL four-neck flask equipped with a thermometer, a stirrer, a raw material feed port and a nitrogen gas inlet, and the mixture was stirred under a dry nitrogen gas stream at 130° C. for 3 hours. After that, the reaction solution was cooled to 25° C., 12.72 g of DDS and 29.68 g of EDM were added to the reaction solution, and the mixture was stirred at 20 to 30° C. for 2 hours. After that, the mixture was stirred at 115° C. for 1 hour and cooled to 30° C. or lower, thereby obtaining 30 wt % polyester amide acid solution which was pale yellow and transparent.

The rotational viscosity of the solution was 36.2 mPa·s. The weight-average molecular weight measured with GPC was 21,000 (in the polystylene conversion).

TABLE 1

| | Synthesis Example 1 | | Synthesis Example 2 | |
|---|---|---|---|---|
| | Materials | Amount | Materials | Amount |
| Tetracarboxylic Dianhydride | ODPA | 183.2 | ODPA | 47.68 |
| Diamine | DDS | 29.33 | DDS | 12.72 |
| Multivalent Hydroxy Compound | 1,4-butanediol | 31.93 | 1,4-butanediol | 9.23 |
| Monovalent Alcohol | Benzyl alcohol | 25.54 | Benzyl alcohol | 55.40 |
| Styrene-Maleic Anhydride Copolymer | — | — | SMA1000P | 144.97 |
| Solvent | MMP | 446.96 | PGMEA | 504.00 |
| | | | EDM | 29.68 |

In Table 1:
MMP: methyl 3-methoxypropionate
ODPA: 3,3′,4,4′-diphenylether tetracarboxylic dianhydride
DDS: 3,3′-diaminodiphenyl sulfone
PGMEA: propylene glycol monomethyl ether acetate
SMA1000P: styrene-maleic anhydride copolymer, manufactured by Kawahara Yuka Co., Ltd.
EDM: diethylene glycol methyl ethyl ether

Next, using the polyester amide acids obtained in Synthesis Examples 1 and 2, thermosetting resin compositions were prepared as described below, cured films were obtained using the thermosetting resin compositions, and the cured films were evaluated (see, Examples 1-5, Comparative Examples 1 and 2, Tables 2-4 and 5).

### Example 1

A 500 mL separable flask equipped with a stirring blade was subjected to nitrogen substitution. 100 g of the polyester amide acid solution obtained in Synthesis Example 1, 60 g of TECHMORE VG3101L (trade name; manufactured by Mitsui Chemicals, Inc.), 4.5 g of 3-glycidoxypropyl trimethoxysilane, 0.47 g of IRGANOX 1010 (trade name; manufactured by Ciba Specialty Chemicals), 170.6 g of dehydrated and purified MMP, and 60.2 g of dehydrated and purified EDM were put into the flask, and the mixture was stirred at room temperature for 5 hours to be homogeneously dissolved. Subsequently, 0.44 g of Byk-344 (trade name; manufactured by BYK-Chemie GmbH) was added to the mixture and stirred at room temperature for 1 hour. The resultant mixture was filtered with a membrane filter having a pore size of 0.2 μm to prepare a coating solution.

Next, the surface of a glass substrate and the surface of a color filter substrate were spin coated with the coating solution at 700 rpm for 10 seconds, and thereafter the substrates were prebaked on a hot plate at 80° C. for 3 minutes to form coating films. After that, the coating films were cured by heating in an oven at 230° C. for 30 minutes, thereby obtaining cured films having the thickness of 1.5 μm.

The cured films thus obtained were evaluated in terms of flatness, heat resistance, transparency, chemical resistance, adhesiveness and sputter resistance. The results of the evaluation are shown in Table 5.

Method for Evaluating Flatness

Step height of the surface of the obtained cured film coating of the color filter substrate was measured using an highly sensitive surface profiler (trade name: P-15, manufactured by KLA TENCOR Corporation). When the maximum value of step height among R, G, and B pixels including black matrix (hereinafter abbreviated as the “maximum step height”) was less than 0.2 μm, it is represented by “∘”, and when the maximum step height was 0.2 μm or more, it is represented by “×.” As the color filter substrate, a pigment-dispersed color filter using a resin black matrix having the maximum step height of about 1.1 μm (hereinafter abbreviated as “CF”) was used.

Method for Evaluating Heat Resistance 1

The glass substrate coated with the obtained cured film was reheated at 250° C. for 1 hour, and thereafter the film remaining ratio after heating compared to the film thickness before heating (the film remaining ratio after heating=film thickness after heating/film thickness before heating) and transmittance at 400 nm after heating were measured. When the film remaining ratio after heating was 95% or more and the transmittance at 400 nm after heating was 95% or more, it is represented by “∘.” When the film remaining ratio after heating was less than 95% or the transmittance at 400 nm after heating was less than 95%, it is represented by “×.”

Method for Evaluating Heat Resistance 2

The cured film was scraped away from the obtained glass substrate with the cured film, and 1% weight loss temperature of the cured film was measured under the following conditions using an apparatus for simultaneously measuring differential heat and thermogravity (trade name: TG/DTA6200, manufactured by SII NanoTechnology Inc.). When the 1% weight loss temperature was 290° C. or higher, it is represented by “∘.” When it was lower than 290° C., it is represented by “×.”

Temperature Conditions: 25° C.→(Rate of temperature increase: 10° C./minute)→350° C.

The weight at 100° C. is regarded as a reference (100%). A temperature at which a 1% weight is lost is referred to as the 1% weight loss temperature.

Method for Evaluating Transparency

With respect to the glass substrate coated with the obtained cured film, transmittance of only the cured film at a wavelength of light of 400 nm was measured using a spectrophotometer (trade name: MICRO COLOR ANALYZER TC-1800M, manufactured by Tokyo Denshoku Technical Center Company Ltd.). When the transmittance was 95% or more, it is represented by “∘.” When it was less than 95%, it is represented by “×.”

Method for Evaluating Chemical Resistance

The glass substrates coated with the obtained cured film were subjected to: an immersion treatment with 5wt % of aqueous sodium hydroxide at 60° C. for 10 minutes (hereinafter abbreviated as “NaOH treatment”); an immersion treatment with a liquid mixture (36% hydrochloric acid: 60% nitric acid: water=40:20:40) at 50° C. for 3 minutes (hereinafter abbreviated as “acid treatment”); an immersion treatment with N-methyl-2-pyrrolidone at 50° C. for 30 minutes (hereinafter abbreviated as “NMP treatment”); an immersion treatment with γ-butyrolactone at 50° C. for 30 minutes (hereinafter abbreviated as “GBL treatment”); an immersion treatment with isopropyl alcohol at 50° C. for 30 minutes (hereinafter abbreviated as “IPA treatment”); and an immersion treatment with ultrapure water at 50° C. for 30 minutes (hereinafter abbreviated as “ultrapure water treatment”), respectively. After that, the film remaining ratio after each treatment, compared to the film thickness before each treatment (the film remaining ratio after each treatment=film thickness after each treatment/film thickness before each treatment), and the transmittance before and after each treatment were measured. When the film remaining ratio after each treatment was 95% or more and the transmittance at 400 nm after each treatment was 95% or more, it is represented by “∘.” When the film remaining ratio after each treatment was less than 95% or the transmittance after each treatment was less than 95%, it is represented by “×.”

Method for Evaluating Adhesiveness

The glass substrate coated with the obtained cured film was subjected to a 24-hour pressure cooker test (hereinafter abbreviated as “PCT treatment”) under the following conditions: temperature=120° C; humidity=100%; and pressure=0.2 MPa. After that, a cross-cut adhesion test was performed by removing the cured film using a tape (JIS-K-5400). The number of remaining parts was counted. When the number of remaining parts/100 was 100/100, it is represented by “∘.” When it was 99 or less/100, it is represented by “×.”

Method for Evaluating Sputter Resistance

An ITO film was formed on the obtained cured film coating the glass substrate by means of sputtering at 200° C. so that a resistance value of 10 Ω/cm² was obtained. The presence or absence of wrinkle generated in the ITO film when cooled to room temperature was observed visually. When there was no wrinkle, it is represented by “∘.” When a wrinkle was generated, it is represented by “×.”

### Example 2

A 500 mL separable flask equipped with a stirring blade was subjected to nitrogen substitution. 100 g of the polyester amide acid solution obtained in Synthesis Example 1, 60 g of TECHMORE VG3101L (trade name; manufactured by Mitsui Chemicals, Inc.), 6 g of trimellitic anhydride, 4.8 g of 3-glycidoxypropyl trimethoxysilane, 0.50 g of IRGANOX 1010 (trade name; manufactured by Ciba Specialty Chemicals), 186.6 g of dehydrated and purified MMP, and 64.2 g of dehydrated and purified EDM were put into the flask, and the mixture was stirred at room temperature for 5 hours to be homogeneously dissolved. Subsequently, 0.46 g of Byk-344 (trade name; manufactured by BYK-Chemie GmbH) was added to the mixture and stirred at room temperature for 1 hour. The resultant mixture was filtered with a membrane filter having a pore diameter of 0.2 μm to prepare a coating solution.

Flatness, heat resistance, transparency, chemical resistance, adhesiveness and sputter resistance were evaluated in a manner similar to that in Example 1. The results of the evaluation are shown in Table 5.

### Example 3

A coating solution was prepared in a manner similar to that in Example 2, except that JER 157S65 (trade name; manufactured by Japan Epoxy Resins Co., Ltd.) was used instead of TECHMORE VG3101L.

Flatness, heat resistance, transparency, chemical resistance, adhesiveness and sputter resistance were evaluated in a manner similar to that in Example 1. The results of the evaluation are shown in Table 5.

### Example 4

A coating solution was prepared in a manner similar to that in Example 2, except that EPPN-501H (trade name; manufactured by Nippon Kayaku Co., Ltd.) was used instead of TECHMORE VG3101L.

Flatness, heat resistance, transparency, chemical resistance, adhesiveness and sputter resistance were evaluated in a manner similar to that in Example 1. The results of the evaluation are shown in Table 5.

### Example 5

A coating solution was prepared in a manner similar to that in Example 2, except that the polyester amide acid solution obtained in Synthesis Example 2 was used instead of the polyester amide acid solution obtained in Synthesis Example 1.

Flatness, heat resistance, transparency, chemical resistance, adhesiveness and sputter resistance were evaluated in a manner similar to that in Example 1. The results of the evaluation are shown in Table 5.

### Comparative Example 1

A coating solution was prepared in a manner similar to that in Example 2, except that a bifunctional epoxy resin, JER 828 (trade name; manufactured by Japan Epoxy Resins Co., Ltd.) was used instead of TECHMORE VG3101L.

Flatness, heat resistance, transparency, chemical resistance, adhesiveness and sputter resistance were evaluated in a manner similar to that in Example 1. The results of the evaluation are shown in Table 5.

### Comparative Example 2

A coating solution was prepared in a manner similar to that in Example 2, except that a methyl methacrylate-glycidyl methacrylate copolymer (the molar ratio is 30:70, and the weight-average molecular weight is 10,000 in the polystyrene conversion) was used instead of TECHMORE VG3101L.

Flatness, heat resistance, transparency, chemical resistance, adhesiveness and sputter resistance were evaluated in a manner similar to that in Example 1. The results of the evaluation are shown in Table 5.

TABLE 2

| | Example 1 | | Example 2 | | Example 3 | |
|---|---|---|---|---|---|---|
| | Materials | Amount | Materials | Amount | Materials | Amount |
| Polyester Amide | Solution of | 100 | Solution of Synthesis | 100 | Solution of Synthesis | 100 |
| Acid | Synthesis Example 1 | | Example 1 | | Example 1 | |
| Epoxy Resin | TECHMORE | 60 | TECHMORE | 60 | JER 157S65 | 60 |
| | VG3101L | | VG3101L | | | |
| Epoxy Curing | — | — | Trimellitic anhydride | 6 | Trimellitic anhydride | 6 |
| Agent | | | | | | |
| Coupling Agent | 3-GPMS | 4.5 | 3-GPMS | 4.8 | 3-GPMS | 4.8 |
| Antioxidant | IRGANOX 1010 | 0.47 | IRGANOX 1010 | 0.5 | IRGANOX 1010 | 0.5 |
| Solvent | MMP | 170.6 | MMP | 186.6 | MMP | 186.6 |
| Solvent | EDM | 60.2 | EDM | 64.2 | EDM | 64.2 |
| Surfactant | Byk-344 | 0.44 | Byk-344 | 0.46 | Byk-344 | 0.46 |

TABLE 3

| | Example 4 | | Example 5 | |
|---|---|---|---|---|
| | Materials | Amount | Materials | Amount |
| Polyester Amide Acid | Solution of Synthesis | 100 | Solution of Synthesis | 100 |
| | Example 1 | | Example 2 | |
| Epoxy Resin | EPPN-501H | 60 | TECHMORE | 60 |
| | | | VG3101L | |
| Epoxy Curing Agent | Trimellitic anhydride | 6 | Trimellitic anhydride | 6 |
| Coupling Agent | 3-GPMS | 4.8 | 3-GPMS | 4.8 |
| Antioxidant | IRGANOX 1010 | 0.5 | IRGANOX 1010 | 0.5 |
| Solvent | MMP | 186.6 | MMP | 186.6 |
| Solvent | EDM | 64.2 | EDM | 64.2 |
| Surfactant | Byk-344 | 0.46 | Byk-344 | 0.46 |

TABLE 4

| | Comparative Example 1 | | Comparative Example 2 | |
|---|---|---|---|---|
| | Materials | Amount | Materials | Amount |
| Polyester Amide Acid | Solution of Synthesis | 100 | Solution of Synthesis | 100 |
| | Example 1 | | Example 1 | |
| Epoxy Resin | JER 828 | 60 | Copolymer A | 60 |
| Epoxy Curing Agent | Trimellitic anhydride | 6 | Trimellitic anhydride | 6 |
| Coupling Agent | 3-GPMS | 4.8 | 3-GPMS | 4.8 |
| Antioxidant | IRGANOX 1010 | 0.5 | IRGANOX 1010 | 0.5 |
| Solvent | MMP | 186.6 | MMP | 186.6 |
| Solvent | EDM | 64.2 | EDM | 64.2 |
| Surfactant | Byk-344 | 0.46 | Byk-344 | 0.46 |

In Tables 2-4:
TECHMORE VG3101L: manufactured by Mitsui Chemicals, Inc.
JER 157S65: manufactured by Japan Epoxy Resins Co., Ltd.
EPPN-501H: manufactured by Nippon Kayaku Co., Ltd.
JER 828: manufactured by Japan Epoxy Resins Co., Ltd.
Copolymer A: Methyl methacrylate-glycidyl methacrylate copolymer
(The molar ratio is 30:70, and the weight-average molecular weight is 10,000 in the polystylene conversion.)
3-GPMS: 3-glycidoxypropyl trimethoxysilane
IRGANOX 1010: manufactured by Ciba Specialty Chemicals
Byk-344: manufactured by BYK-Chemie GmbH

TABLE 5

| | | | | | | Comparative | |
|---|---|---|---|---|---|---|---|
| | Examples | | | | | Examples | |
| Evaluation Items | 1 | 2 | 3 | 4 | 5 | 1 | 2 |
| Flatness | ◯ | ◯ | ◯ | ◯ | ◯ | ◯ | X |
| Heat Resistance 1 | ◯ | ◯ | ◯ | ◯ | ◯ | X | ◯ |
| Heat Resistance 2 | ◯ | ◯ | ◯ | ◯ | ◯ | X | X |
| Transparency | ◯ | ◯ | ◯ | ◯ | ◯ | ◯ | ◯ |
| Chemical Resistance | ◯ | ◯ | ◯ | ◯ | ◯ | ◯ | ◯ |
| Adhesiveness | ◯ | ◯ | ◯ | ◯ | ◯ | ◯ | ◯ |
| Sputter resistance | ◯ | ◯ | ◯ | ◯ | ◯ | X | ◯ |

As is obvious from the results shown in Table 5, the cured films in Examples 1-5 are excellent in flatness and heat resistance, and further, all of transparency, chemical resistance, adhesiveness and sputter resistance thereof are well balanced. On the other hand, the cured film using the bifunctional epoxy resin of Comparative Example 1 is excellent in flatness, but exhibits inferior heat resistance and sputter resistance. The cured film using the epoxy resin having the molecular weight of 5,000 or more of Comparative Example 2 (methyl methacrylate-glycidyl methacrylate copolymer) exhibits inferior flatness. Thus, all the properties were satisfied only in the case where the epoxy resin comprising 3 to 20 epoxy groups and having the weight-average molecular weight of less than 5,000 was used.

### INDUSTRIAL APPLICABILITY

The cured film obtained from the thermosetting resin composition of the invention is also excellent in properties as an optical material such as sputter resistance, transparency and the like. Therefore, the cured film can be utilized as a protective film for various optical materials such as a color filter, an LED luminous element, a light-sensitive element and the like, and a transparent insulating film formed between a TFT and a transparent electrode, or between a transparent electrode and an aligning film.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A thermosetting resin composition comprising a polyester amide acid obtained by reacting a tetracarboxylic dianhydride, a diamine and a multivalent hydroxy compound; an epoxy resin comprising 3 to 20 epoxy groups and having a weight-average molecular weight of less than approximately 5,000; and an epoxy curing agent, wherein the epoxy resin is in an amount of approximately 20 to approximately 400 parts by weight per approximately 100 parts by weight of the polyester amide acid, and wherein the epoxy curing agent is in an amount of 0 to approximately 13 parts by weight per approximately 100 parts by weight of the epoxy resin.

2. The thermosetting resin composition according to claim 1, wherein the polyester amide acid is a reaction product obtained by reacting a tetracarboxylic dianhydride, a diamine, a multivalent hydroxy compound and a monovalent alcohol.

3. The thermosetting resin composition according to claim 1, wherein the polyester amide acid is a reaction product obtained by reacting a tetracarboxylic dianhydride, a diamine, a multivalent hydroxy compound, a monovalent alcohol and a silicon-containing monoamine.

4. The thermosetting resin composition according to claim 3, wherein the silicon-containing monoamine comprises one or more substances selected from 3-aminopropyl triethoxysilane and p-aminophenyl trimethoxysilane.

5. The thermosetting resin composition according to claim 2, wherein the monovalent alcohol comprises one or more substances selected from isopropyl alcohol, allyl alcohol, benzyl alcohol, hydroxyethyl methacrylate, propylene glycol monoethyl ether and 3-ethyl-3-hydroxymethyl oxetane.

6. The thermosetting resin composition according to claim 1, wherein the polyester amide acid is a polyester amide acid obtained by further reacting a styrene-maleic anhydride copolymer.

7. The thermosetting resin composition according to claim 1, wherein the polyester amide acid is obtained by reacting X moles of a tetracarboxylic dianhydride, Y moles of a diamine and Z moles of a multivalent hydroxy compound in a ratio which satisfies relationships defined by formulae (1) and (2):
0.2≦Z/Y≦8.0 (1)
0.2≦(Y+Z)/X≦1.5 (2)

8. The thermosetting resin composition according to claim 1, wherein the polyester amide acid has constitutional units represented by formulae (3) and (4): 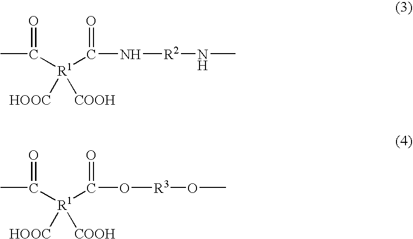
wherein R¹ is a tetracarboxylic dianhydride residue, R² is a diamine residue and R³ is a multivalent hydroxy compound residue.

9. The thermosetting resin composition according to claim 1, wherein the polyester amide acid has a weight-average molecular weight of approximately 1,000 to approximately 50,000.

10. The thermosetting resin composition according to claim 1, wherein the tetracarboxylic dianhydride comprises one or more substances selected from 3,3′,4,4′-diphenylsulfone tetracarboxylic dianhydride, 3,3′,4,4′-diphenylether tetracarboxylic dianhydride, 2,2-[bis(3,4-dicarboxyphenyl)]hexafluoropropanedianhydride and ethylene glycol bis(anhydrotrimellitate).

11. The thermosetting resin composition according to claim 1, wherein the diamine comprises one or more substances selected from 3,3′-diaminodiphenyl sulfone and bis[4-(3-aminophenoxy)phenyl]sulfone.

12. The thermosetting resin composition according to claim 1, wherein the multivalent hydroxy compound comprises one or more substances selected from ethylene glycol, propylene glycol, 1,4-butanediol, 1,5-pentanediol, 1,6-hexanediol, 1,7-heptanediol and 1,8-octanediol.

13. The thermosetting resin composition according to claim 1, wherein the epoxy resin comprises a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-1-methylethyl]phenyl]ethyl]phenoxy]-2-propanol, or 2-[4-(2,3-epoxy propoxy)phenyl]-2-[4-[1,1-bis[4-([2,3-epoxy propoxy]phenyl)]ethyl]phenyl]propane.

14. The thermosetting resin composition according to claim 1, wherein the epoxy curing agent comprises one or more substances selected from trimellitic anhydride and hexahydrotrimellitic anhydride.

15. The thermosetting resin composition according to claim 1, further comprising methyl 3-methoxypropionate as a solvent, and wherein the tetracarboxylic dianhydride is 3,3′,4,4′-diphenylether tetracarboxylic dianhydride; the diamine is 3,3′-diaminodiphenyl sulfone; the multivalent hydroxy compound is 1,4-butanediol; the epoxy resin is a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-1-methylethyl]phenyl]ethyl]phenoxy]-2-propanol, or 2-[4-(2,3-epoxy propoxy)phenyl]-2-[4-[1,1-bis[4-([2,3-epoxy propoxy]phenyl)]ethyl]phenyl]propane; and the epoxy curing agent is trimellitic anhydride.

16. The thermosetting resin composition according to claim 2, further comprising methyl 3-methoxypropionate as a solvent and wherein the tetracarboxylic dianhydride is 3,3′,4,4′-diphenylether tetracarboxylic dianhydride; the diamine is 3,3′-diaminodiphenyl sulfone; the multivalent hydroxy compound is 1,4-butanediol; the monovalent alcohol is benzyl alcohol; the epoxy resin is a mixture of 2-[4-(2,3-epoxy propoxy)phenyl]-2-[4-[1,1-bis[4-([2,3-epoxy propoxy]phenyl)]ethyl]phenyl]propane and 1,3-bis[4-[1-[4-(2,3-epoxy propoxy)phenyl]-1-[4-[1-[4-(2,3-epoxy propoxyphenyl)-1-methylethyl]phenyl]ethyl]phenoxy]-2-propanol, or 2-[4-(2,3-epoxy propoxy)phenyl]-2-[4-[1,1-bis[4-([2,3-epoxy propoxy]phenyl)]ethyl]phenyl]propane; and the curing agent is trimellitic anhydride, the thermosetting resin composition.

17. A cured film comprising the thermosetting resin composition according to claim 1.

18. A color filter comprising the cured film according to claim 17 as a protective film.

19. A liquid crystal display device comprising the color filter according to claim 18.

20. A solid-state image sensing device comprising the color filter according to claim 18.

21. A liquid crystal display device comprising the use of the cured film according to claim 17 as a transparent insulating film formed between a TFT and a transparent electrode.

22. A liquid crystal display device comprising the use of the cured film according to claim 17 as a transparent insulating film formed between a transparent electrode and an aligning film.

23. An LED illuminant comprising the use of the cured film according to claim 17 as a protective film.
